(19) United States
(12) Patent Application Publication
(10) Pub. No.: US 2021/0147027 A1
(43) Pub. Date: May 20, 2021

(54) Spider Web Removing Device

(71) Applicant: Stephen Glenn Morton, Lufkin, TX (US)

(72) Inventor: Stephen Glenn Morton, Lufkin, TX (US)

(21) Appl. No.: 17/090,761

(22) Filed: Nov. 5, 2020

Related U.S. Application Data
(60) Provisional application No. 62/936,739, filed on Nov. 18, 2019.

(51) Int. Cl. B62J 23/00; B08B 1/00; B63B 34/26

(52) U.S. Cl. CPC B62J 23/00; B63B 34/26; B08B 1/001

(57) ABSTRACT

A spider web removing device includes a base mount, a rod adaptor, a telescopic rod, and a quick disconnect fastener. The base mount that secures the spider web removing device to an outdoor vehicle or apparatus is rotatably mounted to the rod adaptor via the quick disconnect fastener. The rod adaptor provides a platform to secure the telescopic rod that effectively removes any spider webs that may present along a path of an outdoorsman. A plurality of first teeth of the base mount and a plurality of second teeth of the rod adaptor are engaged with each other so that the radial movement of the base mount and the rod adaptor can be incrementally controlled.

The current application claims a priority to the U.S. Provisional Patent application Ser. No. 62/936,739 filed on Nov. 18, 2019.

### FIELD OF THE INVENTION

The present invention relates generally to cleaning devices. More specifically, the present invention is a device for effectively removing spider webs. The present invention is specifically designed for removing spider webs in outdoor environments. However, the present invention is not limited to this option, and it may further be adapted for different purposes.

### BACKGROUND OF THE INVENTION

Spider webs often collect on walls, ceilings, and corners from dust charged with static electricity. The problem of removing spider webs has existed for quite a long time. People usually use a broom or a vacuum cleaner to remove the spider webs in hard to reach places. However, these methods are time-consuming, cumbersome, and not suitable for outdoor use. An outdoorsman (for example, a mountain biker or an all-terrain vehicle rider) very frequently encounters spider webs that are positioned by spiders across roads and trails and among trees and other objects. These spider webs are extremely difficult for the outdoorsman to remove or to avoid before the outdoorsman actually comes into contact with the spider web itself. This unforeseeable contact causes spiders and spider webs to come into direct contact with the outdoorsman, and usually occurs across the face and eyes of the outdoorsman. For example, contact with spiders and spider webs to the face and eyes is a major safety hazard for mountain bikers as they have to remove one hand from the handlebars of the bike in attempts to remove the spiders and spider webs from the mountain biker's face and eyes.

The present invention aims to solve some of these problems by disclosing a spider web removing device which can intercept and effectively remove spider webs, thus helping an outdoorsman avoid spider bites and the distracting annoyance of continually clearing spider webs from his face. The present invention is a telescopic rod that can be easily attached to a mountain bike, or any other type of outdoor vehicle, so that the telescopic rod can remove the spider webs before they come into contact with the outdoorsman's face.

### SUMMARY OF THE INVENTION

The present invention is a spider web removing device designed to remove spider webs from trails, roads, and woods. The present invention is an inexpensive and practical device for clearing spider webs. The present invention can be easily and stably fastened to, for example, a mountain bike. The present invention allows for efficient maneuverability of the mountain bike with very minimal visual obstruction.

### BRIEF DESCRIPTION OF THE DRAWINGS

FIG. 1 is a perspective view of the present invention.

FIG. 2 is another perspective view of the present invention.

FIG. 3 is a perspective view of the base mount and the rod adaptor of the present invention.

FIG. 4 is an exploded view of the present invention, without the telescopic rod and showing a type of quick disconnect fastener.

FIG. 5 is a perspective view of rod adaptor of the present invention.

FIG. 6 is a side view of rod adaptor of the present invention, wherein the dash line illustrates the opening of the rod adaptor.

FIG. 7 is a front view of base mount of the present invention.

FIG. 8 is a side view of base mount of the present invention.

FIG. 9 is a front view of the present invention, showing the plane upon which a cross sectional view is taken shown in FIG. 10.

FIG. 10 is a cross section view of the present invention taken along line 10-10 of FIG. 9.

FIG. 11 is another exploded view of the present invention, without the telescopic rod and showing another type of quick disconnect fastener.

FIG. 12 is a perspective view of the present invention, wherein the present invention is installed to a bicycle.

### DETAIL DESCRIPTIONS OF THE INVENTION

All illustrations of the drawings are for the purpose of describing selected versions of the present invention and are not intended to limit the scope of the present invention.

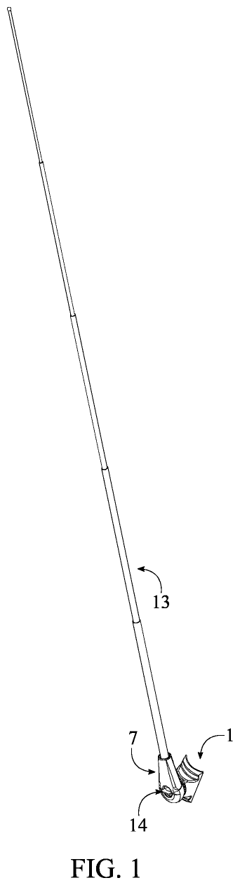

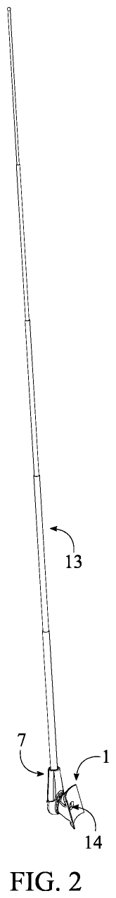

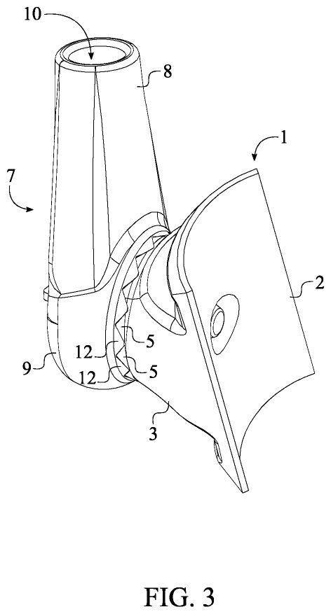

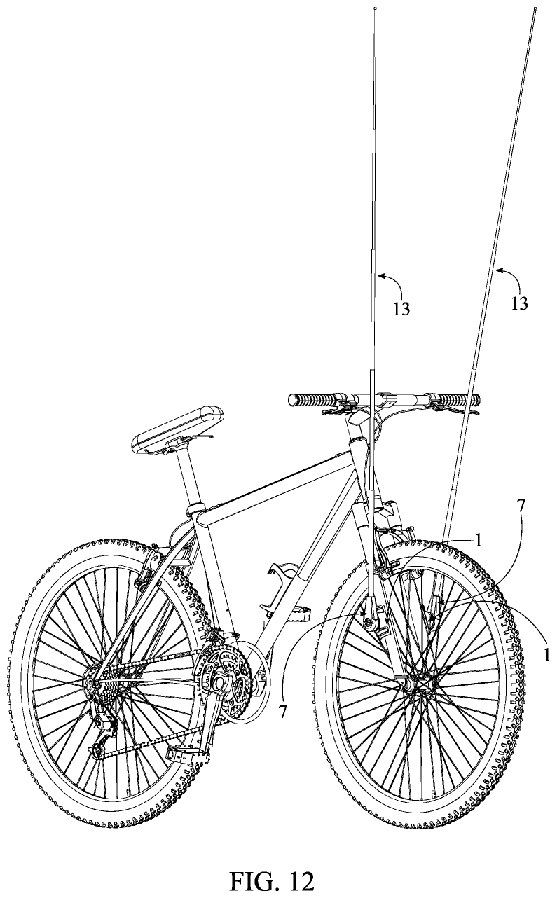

The present invention is a spider web removing device designed to be used with outdoor equipment such as mountain bikes, all-terrain vehicles, and kayaks as shown in FIG. 12. It is an aim of the present invention to provide a spider web removing device that can help an outdoorsman to remove the spider webs from trails, roads, woods, etc. while allowing the outdoorsman to use their hands with the corresponding outdoor activities. For example, the present invention efficiently removes spider webs from a bicycle path while allowing a cyclist to maintain both hands on the handlebar. The present invention is hereinafter explained with respect to a single assembly; however, the outdoorsman can utilize a single assembly or multiple assemblies of the present invention to remove spider webs upon their preference. The present invention comprises a base mount 1, a rod adaptor 7, a telescopic rod 13, and a quick disconnect fastener 14 as shown in FIG. 1-4. In reference to a general configuration of the present invention, the base mount 1 that secures the present invention to outdoor equipment is rotatably mounted to the rod adaptor 7 via the quick disconnect fastener 14. The rod adaptor 7 functions as a platform to secure the telescopic rod 13 that effectively removes any spider webs that may present along a path of an outdoorsman.

In reference to FIG. 1, the base mount 1 that secures the present invention to an outdoor equipment comprises a base body 2, a first connector body 3, a first pin-receiver 4, and a plurality of first teeth 5. The base body 2 is preferably formed into a curved surface or a V-shaped channel so that the base body 2 can be mounted onto a variety of diameters of front forks of a mountain bike. However, the preferred shape of the base body 2 can differ based upon the mounting feature of the outdoor equipment. The first connector body 3 is preferably a circular platform and adjacently connected onto the base body 2. As a result, the first connector is able to outwardly protrude from the base body 2. The first pin-receiver 4 traverses through the first connector body 3 and the base body 2 thus providing a void within the base mount 1 to inserts or rotatably engages the quick disconnect fastener 14. The plurality of first teeth 5 is radially connected around the first connector body 3 and positioned around the first pin-receiver 4. The plurality of first teeth 5 provides a controlled rotation for the base mount 1 so that the user can easily control the radial movement of the base mount 1 with respect to the positioning of the rod adaptor 7.

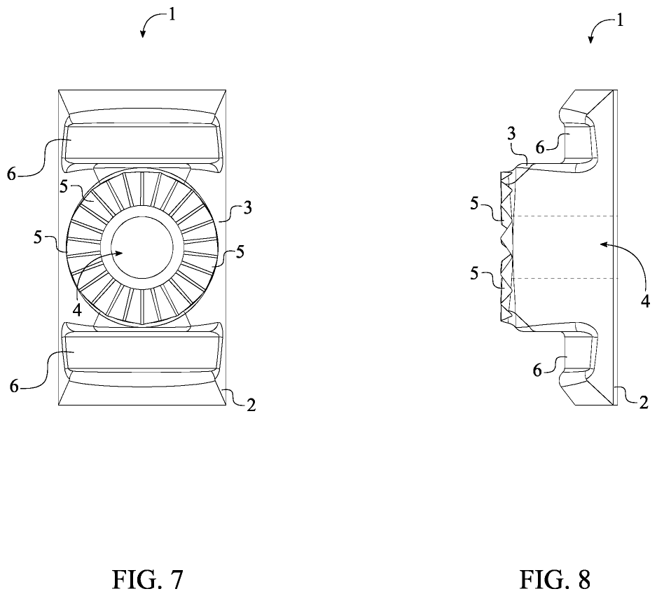

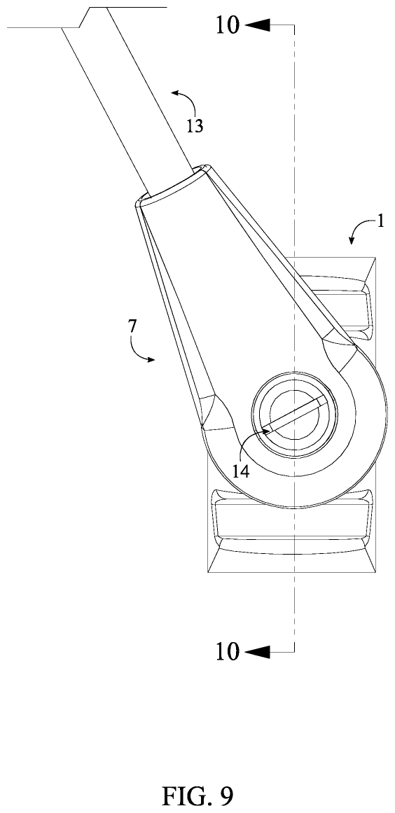

In reference to FIG. 7-8, the base mount 1 further comprises a pair of indentations 6 so that the base mount 1 can be secured to the outdoor equipment. More specifically, the pair of indentations 6 traverses into the base body 2 as the first connector body 3 is positioned in between the pair of indentations 6. Due to the opposite positioning of the pair of indentations 6 about the first connector body 3, the base mount 1 can be symmetrically secured to the outdoor equipment as a pair of straps, clamps, or any other similar fasteners loop through the pair of indentations 6 and around a mounting feature of the outdoor equipment. Furthermore, the base mount 1 further comprises at least one rubber pad that is connected onto the base body 2. For example, the at least one rubber pad and the first connector body 3 are oppositely positioned of each other about the base body 2 and connected onto an inside surface of the base body 2. As a result, when the present invention is mounted to the mounting feature of the outdoor equipment, the at least one rubber pad protects the mounting feature and also keeps the base mount 1 from shifting while in use.

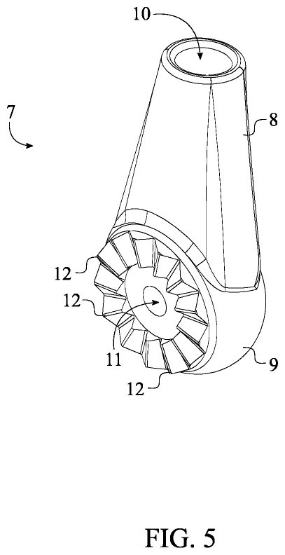

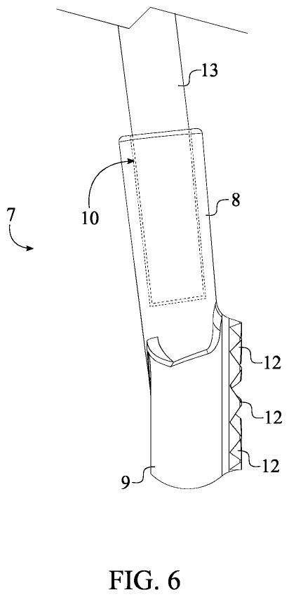

In reference to FIG. 5-6, the rod adaptor 7 that provides a platform to secure the telescopic rod 13 comprises an adaptor body 8, a second connector body 9, a second pin-receiver 11, and a plurality of second teeth 12. The adaptor body 8 and the second connector body 9 are adjacently connected to each other and preferably formed into a teardrop shape. More specifically, the adaptor body 8 is shaped into an elongated section while the second connector body 9 is shaped into a circular section. However, the preferred shape of the rod adaptor 7 body can differ based upon the mounting feature of the outdoor equipment or user preferences. The second pin-receiver 11 traverses through the second connector body 9 and provides a void within the rod adaptor 7 to inserts the quick disconnect fastener 14. The plurality of second teeth 12 is radially connected around the second connector body 9 and positioned around the second pin-receiver 11. The plurality of second teeth 12 provides a controlled rotation for the rod adaptor 7 so that the user can easily control the radial movement of the rod adaptor 7 with respect to the positioning of the base mount 1.

In reference to FIG. 6, the telescopic rod 13 is terminally connected to the adaptor body 8 so that the telescopic rod 13 can be compacted or extended with respect to the rod adaptor 7. Numerous types of retractable rod can be used as the telescopic rod 13 within the present invention. Preferably, a friction type assembly where two or more tubes are fitted together in line with each other. The telescopic rod 13 is designed so that with a moderate pulling force that is applied to a free end of the telescopic rod 13 is able to extend to the two or more tubes into a desired length. Each tube has a first end and a second end and tapers from a larger diameter at the first end to a smaller diameter at the second end. The rod adaptor 7 further comprises an opening 10 that traverses into the adaptor body 8. The opening 10 is oriented along the elongated section thus providing the maximum depth for the opening 10. The telescopic rod 13 is terminally connected to the adaptor body 8 through the opening 10, wherein a fixed end of the telescopic rod 13 is inserted into the opening 10 and internally connected to the adaptor body 8. Resultantly, a free end of the telescopic rod 13 can be compacted towards the rod adaptor 7 or extended away the rod adaptor 7. When the telescopic rod 13 is fully extended, an extended length of the telescopic rod 13 is about 7 feet. When the telescopic rod 13 is fully compacted, a compacted length of the telescopic rod 13 is about 18 inches. The length flexibility between the 18 inches to 7 feet allows the users to easily store the present invention, adjust the height of the telescopic rod 13 upon different outdoor obstacles, and adjust the height of the telescopic rod 13 upon different outdoor equipment. Furthermore, the telescopic rod 13 is manufactured of a material that allows for flexibility. Such flexible material may include, not limited to, fiberglass or other materials with similar properties. Such flexibility prevents the telescopic rod 13 from breaking when the telescopic rod 13 comes into contact with sturdy tree branches or other objects.

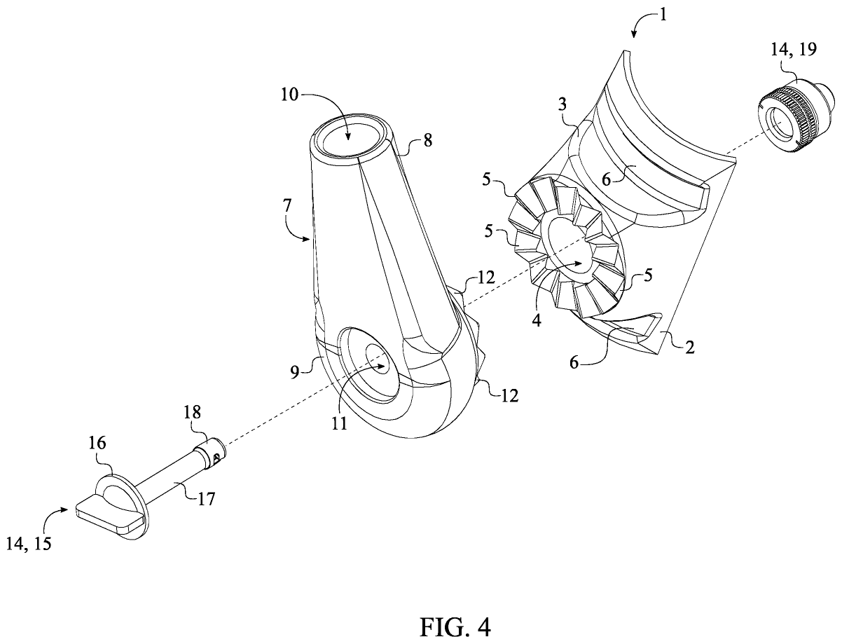

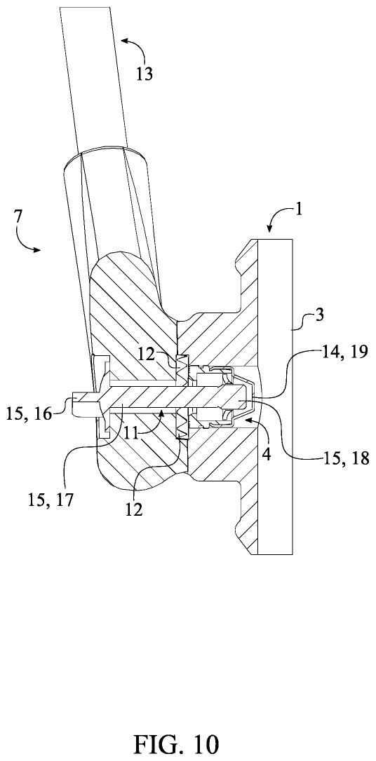

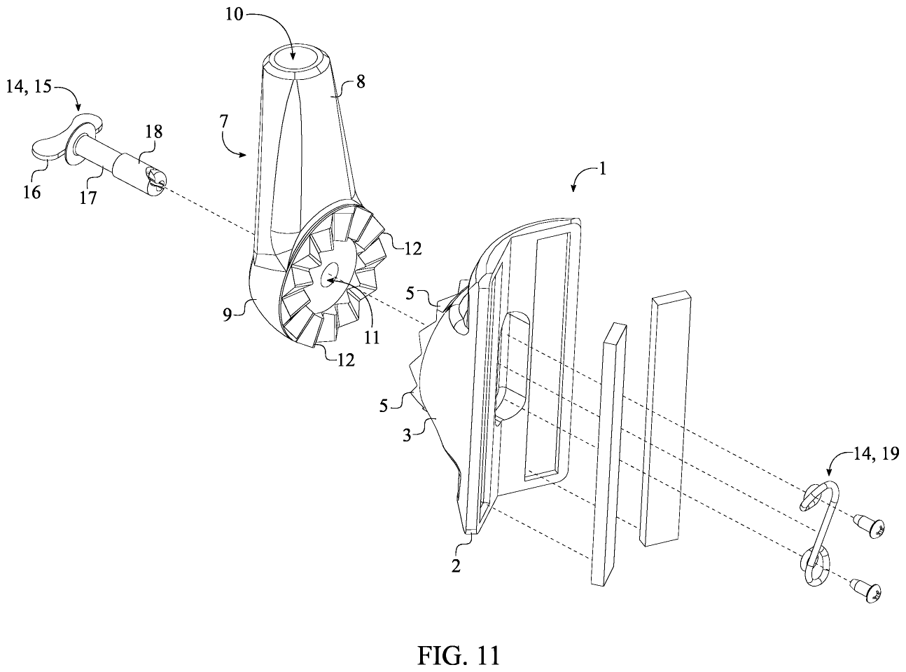

The quick disconnect fastener 14 rotatably mounts the base mount 1 and the rod adaptor 7 together so that the present invention can be angularly adjusted. In reference to FIG. 9-10, the plurality of first teeth 5 and the plurality of second teeth 12 are radially engaged with each other so that the base mount 1 and the rod adaptor 7 can rotatably attached to each other through the quick disconnect fastener 14, the plurality of first teeth 5, and the plurality of second teeth 12. More specifically, the quick disconnect fastener 14 comprises a second interlocking fastener 15 and a first interlocking fastener 19. The first interlocking fastener 19 is integrated into the first connector body 3 through the first pin-receiver 4 so that the second interlocking fastener 15 can be received. The plurality of second teeth 12 is oriented towards the plurality of first teeth 5 thus interlocking the rod adaptor 7 to the base mount 1. A shaft 17 of the second interlocking fastener 15 is concentrically aligned within the second pin-receiver 11 so that a head 16 of the second interlocking fastener 15 can be positioned opposite to the plurality of second teeth 12 and about the second connector body 9. A tip 18 of the second interlocking fastener 15 is then engaged to the first interlocking fastener 19 thus locking the rod adaptor 7 to the base mount 1. In reference to an embodiment of the present invention, a pair of L-shaped tracks that is diametrically positioned of each other is integrated into the tip 18 of the second interlocking fastener 15 as shown in FIG. 4. The pair of L-shaped tracks is slidably engaged with a matching pair of tabs of the first interlocking fastener 19 when the second interlocking fastener 15 is inserted into the first interlocking fastener 19. Then, the head 16 of the second interlocking fastener 15 is rotated about a central axis of the second interlocking fastener 15 thus locking the matching pair of tabs within the pair of L-shaped tracks. In reference to another embodiment of the present invention, a locking channel is integrated into the tip 18 of the second interlocking fastener 15 as shown in FIG. 11. The locking channel is slidably engaged with a locking rod of the first interlocking fastener 19 when the second interlocking fastener 15 is inserted into the first interlocking fastener 19. Then, the head 16 of the second interlocking fastener 15 is rotated about a central axis of the second interlocking fastener 15 thus locking the locking channel with the locking rod.

The present invention may be made of thermoplastic material or be made of metals such as cast aluminum or any other suitable materials or using any suitable combination thereof. It should be understood that the components of the present invention may or may not be made of the same material. Furthermore, it is envisioned that the sizes of the components forming the present invention such as the base mount 1, the rod adaptor 7, the telescopic rod 13, and the quick disconnect fastener 14 can vary based on design requirements.

Although the invention has been explained in relation to its preferred embodiment, it is to be understood that many other possible modifications and variations can be made without departing from the spirit and scope of the invention as hereinafter claimed.

What is claimed is:

1. A spider web removing device comprising:
a base mount;
a rod adaptor;
a telescopic rod;
a quick disconnect fastener;
the base mount comprising a base body, a first connector body, and a plurality of first teeth;
the rod adaptor comprising an adaptor body, a second connector body, and a plurality of second teeth;
the base body and the first connector body being adjacently connected to each other;
the plurality of first teeth being radially connected around the first connector body;
the adaptor body and the second connector body being adjacently connected to each other;
the plurality of second teeth being radially connected around the second connector body;
the telescopic rod being terminally connected to the adaptor body;
the plurality of first teeth and the plurality of second teeth being radially engaged with each other; and
the base mount and the rod adaptor being rotatably attached to each other through the quick disconnect fastener, the plurality of first teeth, and the plurality of second teeth.

2. The spider web removing device as claimed in claim 1 comprising:
the base mount further comprises a first pin-receiver;
the first pin-receiver traversing through the first connector body and base body; and
the plurality of first teeth being radially positioned around the first pin-receiver.

3. The spider web removing device as claimed in claim 1 comprising:
the base mount further comprises a pair of indentations;
the pair of indentations traversing into the base body; and
the first connector body being positioned in between the pair of indentations.

4. The spider web removing device as claimed in claim 1 comprising:
the rod adaptor further comprises a second pin-receiver;
the second pin-receiver traversing through the second connector body; and
the plurality of second teeth being radially positioned around the second pin-receiver.

5. The spider web removing device as claimed in claim 1 comprising:
the rod adaptor further comprising an opening;
the opening traversing into the adaptor body; and
the telescopic rod being terminally connected to the adaptor body through the opening.

6. The spider web removing device as claimed in claim 1, wherein a compacted length of the telescopic rod is about 18 inches.

7. The spider web removing device as claimed in claim 1, wherein an extended length of the telescopic rod is about 7 feet.

8. The spider web removing device as claimed in claim 1 comprising:
the quick disconnect fastener comprising a second interlocking fastener and a first interlocking fastener;
the first interlocking fastener being integrated into the first connector body through the first pin-receiver;
the plurality of second teeth being oriented towards the plurality of first teeth;
a shaft of the second interlocking fastener being concentrically aligned within the second pin-receiver;
a head of the second interlocking fastener being positioned opposite to the plurality of second teeth; and
a tip of the second interlocking fastener being engaged to the first interlocking fastener.
